(19) United States
(12) Patent Application Publication
(10) Pub. No.: US 2023/0214770 A1
(43) Pub. Date: Jul. 6, 2023

(54) METHOD FOR LEARNING RESTOCK PATTERNS FROM REPEATED OBSERVATIONS OF SHELF FACING COUNTS OF CONSUMER PACKAGED GOODS

(71) Applicant: Pensa Systems, Inc., Austin, TX (US)

(72) Inventors: James E. Dutton, Spicewood, TX (US); Joel Iventosch, Austin, TX (US); Michael Pav, St. Petersburg, FL (US); Pinar Kaprali, Istanbul (TR); Bora Yavuz, Istanbul (TR)

(21) Appl. No.: 18/081,664

(22) Filed: Dec. 14, 2022

Related U.S. Application Data
(60) Provisional application No. 63/289,476, filed on Dec. 14, 2021.

(51) Int. Cl. G06Q 10/087

(52) U.S. Cl. CPC G06Q 10/087

(57) ABSTRACT

A method for obtaining a computed expected facing count (CEFC), including obtaining a sequence of actual facing counts (AFCs) during a specified sample window for each of a plurality of stock keeping units (SKUs), wherein each SKU is associated with one of a plurality of products; identifying a subset of the sequence of AFCs as candidate restock events at which it is assumed the product associated with an SKU has been replenished in a shelving area since a previous AFC observation; selecting a set of restock events that are most likely to represent the intentional restock level (EFC) for that SKU; preparing a plurality of EFC lists, wherein each of said plurality of EFC lists contains the EFCs for all the SKUs in a specified shelf area; periodically updating the plurality of EFC lists, thereby obtaining a plurality of updated EFC lists; and using the plurality of updated EFC lists to compute at least one Key Performance Indicator (KPI) for at least one shelf area.

### CROSS-REFERENCE TO RELATED APPLICATION

This application claims the benefit of priority from U.S. Provisional Patent Application No. 63/289,476, which was filed on Dec. 14, 2021, which has the same title and inventors, and which is incorporated herein by reference in its entirety.

### FIELD OF THE DISCLOSURE

The present application relates generally to retail shelf condition metrics, and more specifically to out of stock estimation of Consumer Packaged Goods (CPGs).

### BACKGROUND OF THE DISCLOSURE

Establishments that buy and sell merchandise that consumers use up and replace on a frequent basis, known in the industry as Consumer Packaged Goods or CPGs, are an important part of the economy. Typically, these establishments employ sophisticated automation to track what comes in (supply chain management systems) and goes out (point of sale systems) but have little visibility into what happens to the products in between. However, visibility into on-the-shelf product availability is vitally important, both for in-person and online shoppers.

Recent advances in artificial intelligence, notably the use of artificial neural networks to recognize objects from camera images, make it possible to survey and count inventory and track its movement in a completely automated and objective way. The advent of deep convolutional neural networks (CNNs) as a mechanism for recognizing individual objects within an image or image stream (video) has revolutionized the field (A. Krizhevsky, I. Sutskever, and G. E. Hinton. Imagenet classification with deep convolutional neural networks. In Advances in neural information processing systems, pages 1097-1105, 2012).

Important metrics for retail shelf data include On Shelf Availability (OSA) and Share of Shelf (SoS). OSA measures the percentage of products that are actually available for purchase versus the number that are expected to be available for purchase, SoS measures the percentage of shelf space allocated to each product or brand.

Computing these metrics for a given retail shelf area requires not only an accurate count of the product facings actually seen on the shelf (Actual Facing Counts or AFCs) but also an accurate count of product facings that are expected to be seen (Expected Facing Counts or EFCs). A single observation of a retail shelf results in an AFC List of actual facing counts for each distinct product (SKU) found at that moment in time. Similarly, an EFC List is required to be able to compare actual counts to what is expected to be there.

Constructing and maintaining the EFC Lists for all shelf areas in a given retail store is typically a painstakingly manual process that is also error-prone. Accurate planograms for these shelf areas provide enough information regarding the expected facing counts to be able to compute shelf metrics. However, current planograms are rarely available for every shelf area in every store and they are constantly changing. Moreover, a planogram for a shelf area only reflects the plan or design for the shelf area, often constructed by centralized category managers or merchandizing departments. Individual stores and stocking managers might or might not actually follow those plans. The more valuable questions are, (1) how do individual stores expect to actually restock their shelves, and (2) how often are those expectations met?

There are several broad approaches to EFC estimation. There are also several possible right answers to the question of expected facing counts, depending on who is doing the expecting. For example, category managers and CPG manufacturers sometimes use a planogram of record that details, among other things, a Planogram EFC list. Shelf tags are often used to indirectly indicate the expected number of facings by laying out how much horizontal shelf space is allocated to each SKU, resulting in a shelf tag EFC list. Shelf observers might infer EFCs by visual inspection of one or more photographs, videos or live walkthroughs, which would yield an observed EFC list. Repeated measurements of Actual Facing Counts (AFCs) for a shelf area over time can be used to calculate a computed EFC list.

Each of these types of EFCs are, for various reasons, sometimes wrong. There is no guarantee they agree with one another, and in practice, they usually do not. Furthermore, it is hard to say which, if any, of them should be considered the correct ground truth. Nonetheless, it is interesting and valuable to be able to compare AFCs from individual shelf area observations to each of these, and the same is true when comparing one against the other. For example, how closely does the observed EFC list in a particular store match the expectations in the planogram of record? If you were to walk into a store and count the actual number of facings for each product on a shelf, how would that compare to the planogram of record or the observed EFC list?

### BRIEF DESCRIPTION OF THE DRAWINGS

FIG. 1 is a graph of a first example of AFC data points.

FIG. 2 is a graph of a second example of AFC data points.

FIG. 3 is a flow diagram depicting an overall process of the type disclosed herein for computing EFCs.

FIG. 4 is a flow diagram depicting the calculation details of a process of the type disclosed herein for computing EFCs.

### SUMMARY OF THE DISCLOSURE

In one aspect, a method for obtaining a computed expected facing count (CEFC), comprising obtaining a sequence of actual facing counts (AFCs) during a specified sample window for each of a plurality of stock keeping units (SKUs), wherein each SKU is associated with one of a plurality of products; identifying a subset of the sequence of AFCs as candidate restock events at which it is assumed the product associated with an SKU has been replenished in a shelving area since a previous AFC observation; selecting a set of restock events that are most likely to represent the intentional restock level (EFC) for that SKU; preparing a plurality of EFC lists, wherein each of said plurality of EFC lists contains the EFCs for all the SKUs in a specified shelf area; periodically updating the plurality of EFC lists, thereby obtaining a plurality of updated EFC lists; and using the plurality of updated EFC lists to compute at least one Key Performance Indicator (KPI) for at least one shelf area.

In another aspect, a method for determining a computed expected facing count (CEFC), comprising obtaining a previously determined CEFC; receiving a plurality of shelf observations which report the actual facing counts (AFCs) of a plurality of SKUs or of products associated with the plurality of SKUs; creating a set of the plurality of AFCs to include in a sample window; determining a set of potential restock events; using the set of potential restock events to determine whether to update the CEFC for the SKUs in a given shelf area; if a determination is made to update the CEFC for the SKUs in a given shelf area, calculating CEFCs for all of the SKUs in the given shelf area, thereby obtaining a set of calculated CEFCs; creating a candidate expected facing count (EFC) list from the set of calculated CEFCs; and if publication criteria are met, publishing the candidate EFC list.

### DETAILED DESCRIPTION

In light of the foregoing, there is currently a need in the art for methods of determining restock patterns of CPGs from AFCs. There is further a need in the art for methods of determining Computed EFC (CEFC) lists based on a sequence of AFC lists obtained through repeated observations of retail shelves. These and other needs may be met by the systems and methodologies disclosed herein.

Systems and methodologies are disclosed herein for automatically obtaining a Computed EFC (CEFC) list based on a sequence of AFC lists obtained through repeated observations of retail shelves. In a preferred embodiment, these systems and methodologies focus on how the shelf is typically restocked, not on what the shelf area typically looks like. In other words, preferred embodiments of these systems and methodologies focus primarily (and sometimes exclusively) on measurements of shelf space, as determined by the number of facings of products on the shelf. A facing count is defined to be the cardinal number of product instances with the same SKU (UPC or GTIN) that are visible at a given moment. These facing counts may be derived from human observation or machine classification.

In order to achieve the foregoing, systems and methodologies are disclosed herein which:

Accumulate a sequence of actual facing counts (AFCs) for each distinct SKU during a specified sample window;

Identify a subset of AFCs as candidate restock events at which it is assumed the SKU has been replenished in the shelf area since the last prior AFC observation;

Select the restock events that are most likely to represent the intentional restock level (EFC) for that SKU;

Accumulate the EFCs for all the SKUs of a specified shelf area into an EFC List for that shelf area;

Remove products from the EFC list that are no longer showing evidence of shelf replenishment; and
Periodically publish updated EFC Lists to accommodate computation of various Key Performance Indicators (KPIs) for the shelf area.

It is to be noted that computations and inferences made concerning the typical restock patterns of retail shelf areas pre-supposes that such typical replenishment behaviors actually exist. However, if shelves are being restocked haphazardly (as, for example, by filling open shelf space with any available products), then no such identifiable patterns will exist, and any attempt to compute or infer them will ultimately result in incorrect KPIs.

Preferred embodiments of the systems and methodologies disclosed here are robust with respect to some corner cases where expected restock patterns are occasionally interrupted by periods of random or unpredictable replenishment. Such robustness against temporary disruptions was severely tested during the initial longitudinal data collection period used to develop and test the disclosed systems and methodologies. This test period included the first half of the year 2020, during which the global pandemic caused by SARS-CoV-2 disrupted supply chains and stock delivery to an unprecedented degree.

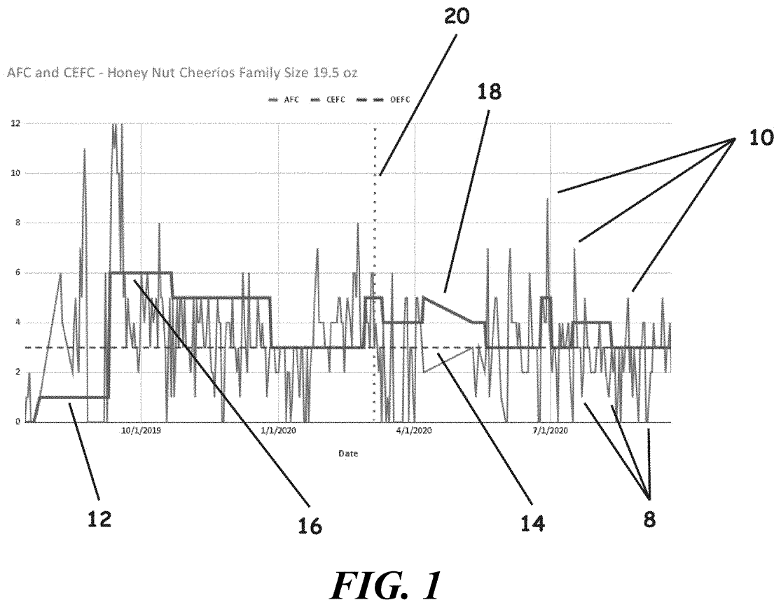

Referring now to the drawings (in which like reference designators refer to like elements), FIG. 1 depicts a first particular, non-limiting embodiment of an example data set for a single SKU representing approximately one year's worth of AFC samples shown as points 8 and 10 and other points on the jagged line. Note the Actual Facing Counts (AFCs) for this SKU range from zero to twelve over the course of the year. The initial portion of the graph in region 12 shows an initialization period in which insufficient data had been collected to perform the EFC calculation. To test the robustness of the methods employed herein, the data set also includes a gap in measurement data 18 during the weeks following the emergency declaration 20 of the Covid pandemic in the United States on Mar. 13, 2020. The dashed red line 14 represents the observed EFC level for this SKU as judged by human observers. Note this observed facing count stays constant at three facings over the entire year. The solid green line 16 is a computed EFC for this SKU. This example was computed using one of the possible embodiments of the methodologies disclosed herein.

Still referring to FIG. 1, the AFC points labeled 8 are some of the instances where the facing count changed from a higher value to a lower value from one observation to the next. Although it is possible that the SKU was restocked between those two observations and then depleted back down to a lower level, that is not the most likely scenario. However, for those sample points labeled 10 where the AFC values go from a lower value to a higher one, it is highly likely that the SKU was restocked in the interim. For these events, it is possible, though not certain, the higher AFC value represents the actual number of facings on the shelf immediately after restocking.

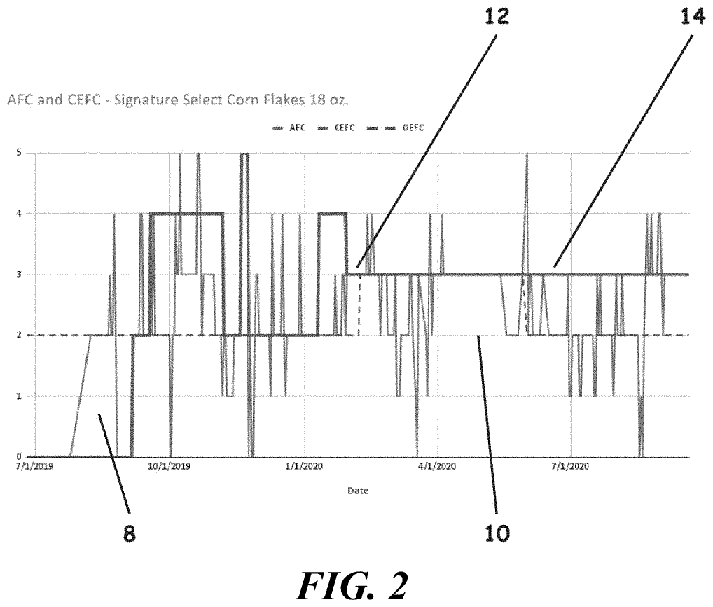

FIG. 2 depicts, for illustration purposes only, a second example data set which shows the same initialization period 8 and Covid-related measurement gap 10. In this example, the dashed line representing the human-observed EFC for this SKU changes from two facings to three facings in mid-March of 2020. This is likely a response by the retailer to the onset of the pandemic demand and supply chain uncertainty that began during that period of time. It is notable that the computed EFC reacts more quickly to this abrupt change in restocking behavior. The computed value jumps from two to three facings more quickly in 12 and then stays there, whereas the human judged restock level reduced back down to two.

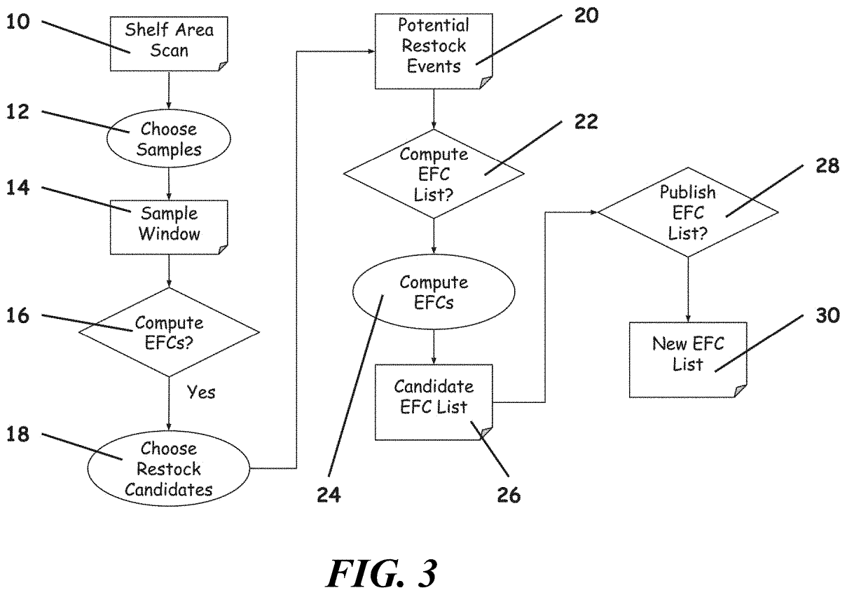

FIG. 3 is a flowchart of a preferred embodiment of the methodology disclosed here for computing the EFC lists for all the SKUs in a shelf area (e.g., an aisle) of a retail store. Each time a shelf observation reports the AFCs of each of the SKUs 10, an observation is chosen 12 as to which of these observations will be included in the sample window from which EFCs will be computed. In some embodiments, the choice 12 may be all AFC observations that occur after a given point in time. In other embodiments, the sample window may be limited by the maximum number of observations rather than by the time period.

The AFC samples are collected in a sample window 14 which is a data structure that sequences the observations chronologically from oldest to newest. In 16, a decision is made whether to re-compute the EFC for a single SKU based on some set of criteria. In some embodiments, this may involve choosing to re-compute the EFC of a SKU only if there is sufficient evidence of restocking behavior to be able to make a reliable inference.

For all chosen SKUs, first a set of AFCs representing potential restock events is chosen 18 and placed into a collection of potential restock events 20. Based on the collected evidence of potential restock events, a decision is made 22 whether to compute a new EFC list for all the SKUs in the given shelf area. If so, EFCs are computed 24 for all SKUs and are collected as a candidate EFC list 26. Finally, a decision is made 28 whether to publish this new EFC list 30 and begin using it to compute KPIs. In some embodiments, this decision may be based on the proportion of SKUs that had changed EFCs since the last published list.

The foregoing are some possible embodiments of the various steps that may be involved in the process depicted in FIG. 3. These embodiments are illustrative and are not intended to be limiting. In some embodiments of the systems and methodologies described herein, the choice of which AFC samples to include in the sample window 12 may be based upon time, so that only the observations recorded in the last fixed period of time are used to computed EFCs. In some embodiments of the systems and methodologies described herein, the choice of which AFC samples to include in the sample window 12 may be based on the number of AFC observations. For example, only the last n observations may be included. In some embodiments of the systems and methodologies described herein, the choice of whether to compute an EFC for a SKU 16 may be based on the number of potential restock events observed, which includes events where an AFC changed from a lower value to a higher value from one observation to the next.

In some embodiments of the systems and methodologies described herein, EFCs may be computed 24 by using the statistical mode of the potential restock levels in order to discover the most often used restock levels. Since the mode is not guaranteed to exist for some sequences of measurements, the existence of a mode may be taken as evidence that there is a predictable restock pattern for a given SKU. If no such mode exists, the computed EFC for that SKU may remain as it was.

In some embodiments of the systems and methodologies described herein, EFCs may be computed 24 by using one or more machine learning models that are trained using various inputs including the longitudinal EFC data in combination with external events such as day-of-week, season, holidays, weather conditions, and other conditions that may cause supply chain or other stock-related disruptions.

In some embodiments of the systems and methodologies described herein, the decision whether to publish a newly-computed EFC list 28 may be based upon the proportion of SKUs in the shelf area that have changed their computed EFC values. If this ratio is larger than some parameterized value, the EFC list will be published to the rest of the system.

In some embodiments of the systems and methodologies described herein, the decision whether to publish a newly-computed EFC list 28 may rely on human-assisted review and approval process of the candidate EFC list. In some embodiments of the systems and methodologies described herein, the decision whether to publish a newly-computed EFC list 28 may seek to minimize the frequency of EFC list publication by requiring a certain minimum number of days has elapsed since the last publication. In some embodiments of the systems and methodologies described herein, the decision whether to publish a newly-computed EFC list 28 may be based on various combinations and sub-combinations of the foregoing methods.

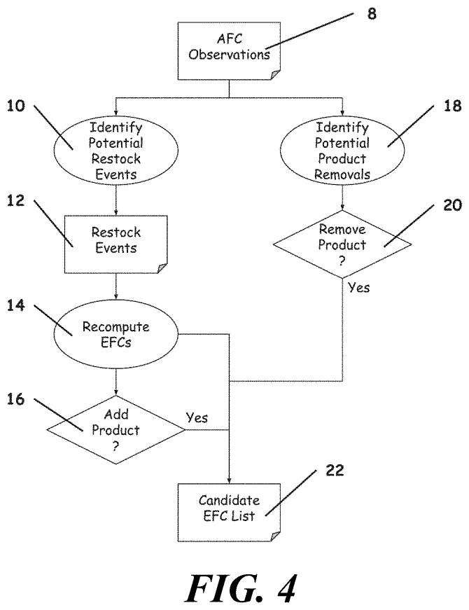

FIG. 4 depicts a particular, nonlimiting embodiment of the methodology used to compute the Candidate EFC List. Beginning with a time-sequenced collection of the most recent Actual Facing Count observations 8 within the defined sample window, the disclosed method proceeds along two branches.

To identify and compute new EFCs for those products that already exist in a previous EFC list, the process first examines the AFC samples for events where the AFC for a given product changes from a lower value to a higher value on consecutive observations of that product in step 10 which produces a list of potential restock events 12. The potential restock events are examined 14 to determine if there is statistically significant evidence that a product already in the prior EFC list is routinely being restocked to a certain level. If so, this restock level becomes the new EFC for that product and is added to the Candidate EFC List 22. If there is evidence that a new product is being restocked on the shelf (a product that does not already exist on the prior EFC list), a decision is made 16 whether to add the new product to the Candidate EFC List 22.

This part of the process may re-compute new EFCs for existing products on the list and it may identify and add new products that were not on the prior list. However, it does not identify products that are no longer being stocked (e.g., that have been removed from the planogram), since absence of evidence of restocking does not constitute evidence of absence of the SKU.

Determining when to remove a SKU from the EFC list may be a challenging decision. Even if the AFC of the product never increases from a lower value to a higher one, it may still exist on the shelf, perhaps because it did not require replenishment during the sample window. This situation may persist for low-velocity items that may go for significant periods of time without requiring restocking on the shelf. Conversely, even if no instances of a given product appears on the shelf (AFC=O) for some number of observations, that does not necessarily mean it should no longer be expected to be restocked at a later time. This situation may occur because of supply chain issues or inventory inaccuracies in the store.

With these complexities in mind, the disclosed method makes a statistical estimate 18 to construct a candidate list of potential removals from the EFC list A decision 20 is then made whether to remove them from the Candidate EFC List 22. In some embodiments, this decision process 20 may choose to remove products whose AFCs have been zero over the entire sample window (or during a sufficiently large portion of it) without any evidence of restocking of that product.

In some embodiments of the systems and methodologies described herein, the identification of potential restock events 10 may be accomplished by selecting those events where a product's AFC changes from a smaller value to a larger one. In some embodiments of the systems and methodologies described herein, the identification of potential restock events 10 may consider evidence apart from just the AFCs to determine whether a restock has occurred. Some examples of such external evidence may include, for example, a change in packaging (e.g., seasonal packaging of the same SKU) or a change in the physical positioning of the product on the shelf. In some embodiments of the systems and methodologies described herein, the identification of potential restock events 10 may utilize additional temporal information, such as time of day, day of week, or seasonal variations of restocking behaviors. In some embodiments of the systems and methodologies described herein, the identification of potential restock events 10 may utilize prior knowledge of restock patterns, including knowledge of which products are typically restocked at night from an on-premises or warehouse inventory, versus those that are typically restocked during the day by Direct Store Delivery (DSD) by CPG distributors.

In some embodiments of the systems and methodologies described herein, the computation of EFCs 14 may be accomplished by computing the statistical mode over all the events where a product's AFC changes from a smaller value to a larger one (in other words, by finding the AFC value most often observed immediately after a product is potentially restocked on the shelf). In some embodiments of the systems and methodologies described herein, the computation of EFCs 14 may be accomplished using machine learning, including deep learning techniques.

In some embodiments of the systems and methodologies described herein, the decision 16 whether to add a new product to the EFC list may be based on how many observations in the sample window found that product on the shelf. In some embodiments of the systems and methodologies described herein, the decision 16 whether to add a new product to the EFC list may be based on whether the potentially new product belongs to the same product category as the other products in the same shelf area. For example, misplaced products like a cola can in the cereal aisle may be ignored.

In some embodiments of the systems and methodologies described herein, the decision 16 whether to add a new product to the EFC list may account for equivalency classes of SKUs that are commonly substituted for one another during restocking. For example, a beer distributor might choose to routinely restock three facings of beer from a certain craft brewery based on whatever particular SKUs are available each day. The UPCs may change at each restock event, but are always chosen from the same substitution class.

In some embodiments of the systems and methodologies described herein, the decision 20 whether to remove a product from the EFC list may be based on whether a product has a zero AFC for some minimum number of consecutive, most recent observations.

In some embodiments of the systems and methodologies described herein, the decision 20 whether to remove a product from the EFC list may be based on whether the product has a zero AFC for some minimum contiguous, most recent time period. In some embodiments of the systems and methodologies described herein, the decision 20 whether to remove a product from the EFC list may require confirmation from a human auditor. In some embodiments of the systems and methodologies described herein, the decision 20 whether to remove a product from the EFC list may include correlation analyses with other EFCs in the Candidate EFC List 22. For example, if the AFC of a particular product falls to zero at the same time another (perhaps competitive) product sees a corresponding increase in its calculated EFC, this may be taken as evidence that the product with AFC=O has indeed been replaced with the competitive product and that it should be taken off the Candidate EFC List. In some embodiments of the systems and methodologies described herein, the decision 20 whether to remove a product from the EFC list may utilize external factors such as prior knowledge that a planogram reset has occurred in the store.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

What is claimed is:

1. A method for obtaining a computed expected facing count (CEFC) for a shelf area containing a plurality of consumer packaged goods (CPGs), the method comprising:
obtaining, from said shelf area, a sequence of actual facing counts (AFCs) during a specified sample window for each of a plurality of stock keeping units (SKUs), wherein each SKU is associated with one of a plurality of products;
identifying a subset of the sequence of AFCs as candidate restock events at which it is assumed the product associated with an SKU has been replenished in a shelving area since a previous AFC observation;
selecting a set of restock events that are most likely to represent the intentional restock level (EFC) for that SKU;
preparing a plurality of EFC lists, wherein each of said plurality of EFC lists contains the EFCs for all the SKUs in a specified shelf area;
periodically updating the plurality of EFC lists, thereby obtaining a plurality of updated EFC lists; and
using the plurality of updated EFC lists to compute at least one Key Performance Indicator (KPI) for said at least one shelf area.

2. The method of claim 1, further comprising;
removing products from the EFC list that are no longer showing evidence of shelf replenishment.

3. The method of claim 1, wherein the previous AFC observation is the most recent previous AFC observation.

4. The method of claim 1, further comprising:
using the plurality of updated EFC lists to compute at least one Key Performance Indicator (KPI) for each of a plurality of shelf areas.

5. The method of claim 1, further comprising:
using the plurality of updated EFC lists to compute a plurality of Key Performance Indicators (KPIs) for at least one shelf area.

6. The method of claim 1, further comprising:
using the plurality of updated EFC lists to compute a plurality of Key Performance Indicators (KPIs) for each of a plurality of shelf areas.

7. The method of claim 1, further comprising:
periodically publishing the plurality of updated EFC Lists to a server.

8. The method of claim 1, wherein obtaining a sequence of AFCs during a specified sample window for each of a plurality of SKUs includes obtaining at least one image of a shelf area using an imaging device mounted on a movable platform.

9. The method of claim 1, wherein obtaining a sequence of AFCs during a specified sample window for each of a plurality of SKUs includes obtaining a plurality of images of a plurality of shelf areas using an imaging device mounted on a movable platform.

10. The method of claim 8, wherein the movable platform is a drone.

11. The method of claim 8, wherein the movable platform is a cart.

12. A method for determining a computed expected facing count (CEFC), comprising:
obtaining a previously determined CEFC;
receiving a plurality of shelf observations which report the actual facing counts (AFCs) of a plurality of SKUs or of products associated with the plurality of SKUs;
creating a set of the plurality of AFCs to include in a sample window;
determining a set of potential restock events;
using the set of potential restock events to determine whether to update the CEFC for the SKUs in a given shelf area;
if a determination is made to update the CEFC for the SKUs in a given shelf area, calculating CEFCs for all of the SKUs in the given shelf area, thereby obtaining a set of calculated CEFCs;
creating a candidate expected facing count (EFC) list from the set of calculated CEFCs; and
if publication criteria are met, publishing the candidate EFC list.

13. The method of claim 12, wherein the publication criteria are met if the proportion of EFCs which changed since a previous iteration of the method exceeds a predetermined threshold value.

14. The method of claim 12, wherein the set of shelf observations included in the sample window are all AFCs occurring after a specified point in time.

15. The method of claim 12, wherein the set of shelf observations included in the sample window is the maximum number of AFCs.

16. The method of claim 12, wherein the sample window is a data structure in which the shelf observations are sequenced chronologically.

17. The method of claim 12, wherein the EFC is recomputed only if there is evidence of restocking behavior.

18. The method of claim 12, wherein creating a set of the plurality of AFCs to include in a sample window includes determining which of the AFCs occurred in a fixed period of time.

19. The method of claim 12, wherein creating a set of the plurality of AFCs to include in a sample window includes selecting the n most recent AFCs, wherein n is an integer, and wherein n>0.

20. The method of claim 12, wherein using the set of potential restock events to determine whether to update the CEFC for the SKUs in a given shelf area includes determining whether an AFC changed from a lower value to a higher value between two consecutive observations.

21. The method of claim 12, wherein using the set of potential restock events to determine whether to update the CEFC for the SKUs in a given shelf area includes the identification of potential restock events changes in packaging and changes in the physical positioning of a product on a shelf

22. The method of claim 12, wherein using the set of potential restock events to determine whether to update the CEFC for the SKUs in a given shelf area includes utilizing prior knowledge of restock patterns.

23. The method of claim 12, wherein using the set of potential restock events to determine whether to update the CEFC for the SKUs in a given shelf area includes utilizing prior knowledge of which products are typically restocked at night from an on-premises or warehouse inventory, versus those that are typically restocked during the day by Direct Store Delivery (DSD) by CPG Distributors.

24. The method of claim 12, wherein using the set of potential restock events to determine whether to update the CEFC for the SKUs in a given shelf area includes computing a statistical mode over all the events where a product's AFC has changed from a smaller value to a larger one.

25. The method of claim 12, wherein using the set of potential restock events to determine whether to update the CEFC for the SKUs in a given shelf area includes finding the AFC value most often observed immediately after a product is potentially restocked on the shelf.

26. The method of claim 12, wherein using the set of potential restock events to determine whether to update the CEFC for the SKUs in a given shelf area includes the use of machine learning.

27. The method of claim 26, wherein the use of machine learning includes the use of deep learning techniques.

28. The method of claim 12, wherein the set of potential restock events includes temporal events.

29. The method of claim 28, wherein the temporal events include events selected from the group consisting of time of day and day of week.

30. The method of claim 28, wherein the temporal events include seasonal variations of restocking behaviors.

31. The method of claim 13, wherein calculating CEFCs for all of the SKUs in the given shelf area includes using a statistical mode of the potential restock levels in order to discover the most often used restock levels.

32. The method of claim 26, wherein calculating CEFCs for all of the SKUs in the given shelf area includes keeping the current value of the EFC for a SKU if no such mode exists.

33. The method of claim 12, wherein calculating CEFCs includes using at least one machine learning model that is trained using longitudinal EFC data in combination with at least one item selected from the group consisting of day-of-week, season, holidays, weather conditions, supply chain disruptions and stock-related disruptions.

34. The method of claim 12, wherein the publication criteria includes the proportion of SKUs in the shelf area that have changed their CEFC values.

35. The method of claim 12, wherein the publication criteria includes human-assisted review and approval process of the candidate EFC list.

36. The method of claim 12, wherein the publication criteria includes human-assisted review and approval process of the candidate EFC list.

37. The method of claim 12, wherein the publication criteria is selected to minimize the frequency of EFC list publication by requiring a certain minimum number of days has elapsed since the last publication.

38. The method of claim 12, wherein the decision to add a new product to the EFC list is based on the number of observations in the sample window that found that product on the shelf.

39. The method of claim 12, wherein the decision to add a new product to the EFC list is based on whether the new product belongs to the same product category as the other products in the same shelf area.

40. The method of claim 12, wherein the decision to add a new product to the EFC list accounts for equivalency classes of SKUs that are commonly substituted for one another during restocking.

41. The method of claim 12, wherein the decision to remove a product from the EFC list is based on whether the product has a zero AFC for some minimum number of consecutive observations.

42. The method of claim 12, wherein the decision to remove a product from the EFC list is based on whether the product has a zero AFC for some minimum number of consecutive observations.

43. The method of claim 12, wherein the decision to remove a product from the EFC list is based on whether the product has a zero AFC for some minimum contiguous time periods.

44. The method of claim 12, wherein the decision to remove a product from the EFC list requires confirmation from a human auditor.

45. The method of claim 12, wherein the decision to remove a product from the EFC list includes correlation analyses with other EFCs in the candidate EFC List.

46. The method of claim 12, wherein the decision to remove a product from the EFC list includes prior knowledge that a planogram reset has occurred.
